(19) United States
(12) Patent Application Publication
(10) Pub. No.: US 2016/0125140 A1
(43) Pub. Date: May 5, 2016

(54) Universal Electronic Personal Health Records Software System

(71) Applicant: Robert Higgs, Evansville, IN (US)

(72) Inventor: Robert Higgs, Evansville, IN (US)

(21) Appl. No.: 14/528,621

(22) Filed: Oct. 30, 2014

(51) Int. Cl. G06F 19/00

(52) U.S. Cl. CPC G06F 19/322

(57) ABSTRACT

An online system and method for transmitting patient medical records among various server computers and client computers coupled together via a network or cloud system. The online system includes a telemedicine/EHR module configured as a software application accessible to a user terminal that is in communication with a personal health records module for receiving and managing patient records, and a physician's module for receiving selected patient records from the telemedicine/EHR module and the personal health records module. The present invention provides total interoperability of patient medical records information between all present EHR/EMH electronic medical records based systems.

### CROSS REFERENCES TO RELATED APPLICATIONS

U.S. Provisional Application for Patent No. 61/897,417, filed Oct. 30, 2013, with title “Universal Electronic Personal Health Records Software System” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present disclosure relates to a system and method for capturing, storing, retrieving, and transmitting patient medical records, including longitudinal history and imaging throughout the healthcare system environment, and more particularly, to a system and method for communicating patient medical records that provides optimal medical information service to a subscribed recipient by managing an integrated medical information processing system. The present invention provides total interoperability of patient medical records information between all present EHR/EMR electronic medical records base systems.

2. Brief Description of Prior Art

Comprehensive medical care often requires a patient to visit more than just one doctor. While many patients have established a long-standing relationship with their primary care provider, they are generally unfamiliar with more specialized doctors until medical circumstances necessitate a referral to one. Upon receiving a referral, the patient is usually left to arrange an actual appointment with the specialist. However the patient usually relies upon the patient's primary care provider to timely forward the patient's relevant medical records to the specialist prior to the scheduled appointment. There is lithe transparency in this process, and under unfavorable circumstances a patient may find himself/herself referred to a doctor who has not been given access to the necessary medical information relating to that patient due to slow delivery, mistaken delivery, and/or failure to deliver. These hurdles may cause delays in medical care, and in some cases even dissuade patients from complying with their primary care provider's recommendation to seek additional medical care from a specialist.

In telemedicine, consultations between patient/physician and remote physician are often being conducted without the benefit of the patient's medical history being available to the consulting remote physician. Additionally, existing EHR/EMR systems do not always communicate with each other whereby patient information can be exchanged.

The problem does not end with the sharing of patient's medical records. There is no protocol for sharing of patient information between the primary and secondary care offices. The process requires someone to establish communications between one or more of the patient's primary care physicians and the secondary care physician(s). The inefficacies in managing this process are a drain on both the primary and secondary physician(s) offices. Often times, the patient, who has the least amount of medical knowledge and often an inability to anticipate or articulate the critical nature or timing of the referral, is left calling one or both offices and communicating with a receptionist who cannot independently determine what the next step in the process should be, without again involving either the primary or secondary care physician(s).

The issues described above have been long-standing problems for both physicians and patients, and substantially interfere with the ability to provide appropriate and cost effective medical care. Every existing electronic medical records based system known to applicant relies upon the health care institution and/or care provider to manage the patient's medical information independently.

The present invention provides total interoperability of patient medical records information between all present EHR/EMR electronic medical records based systems. While other similar Personal Health Records (PHR) systems contain a very limited set of data to be collected and stored, and do not have the capability of communicating with disparate systems, the present invention provides every user/patient with the means of ownership of their medical records with the ability to create, manage, retrieve, collect, parse, report, transmit to and from any other licensed healthcare provider.

### SUMMARY OF THE INVENTION

In one or more embodiments of the present invention, an apparatus and method are provided that allows patients, with the assistance of doctors and their administrative staff, to manage the process of physician referrals, whereby a patient is referred from one physician (primary care provider) to another physician (the referred-to or receiving physician or specialist) for a particular medical procedure, or analysis or care.

In the preferred embodiment, a system and method is available for creating, managing, retrieving, collecting, parsing, reporting, transmitting and sharing of patients medical records throughout the continuum of care involving all care providers, either primary and secondary care providers and/or facilities. The present system allows various means of communications and medical records transfer between multiple health care practitioner practice groups, multiple hospitals and multiple patients. The system's servers provide a network based service to the patient and all participating care providers, in order to allow the patient's medical records to be made available to selected practitioner groups, hospitals and medical specialists, by providing a web-based data processing service that can communicate electronically via authenticated and encrypted email with other medical providers. In the alternative, the services provided to one or more practice groups, one or more hospitals, and/or one or more medical provider(s).

These new features bring significant benefits to patients, doctors and hospitals, increasing the efficiency of their work flows and improving patient care while reducing administrative costs, and the probability of errors in patient care. The present system further provides a system and method for eliminating inefficacies in the sharing of patient information.

The present invention defines a Personal Health Records Web Portal that provides the patient with ownership of their longitudinal medical history with the ability to transmit the patient's data to other medical providers, such as a referred-to consulting physician.

The personal health records module as defined, was developed in accordance with all applicable standards involving functionality and capabilities of an Electronic Health/Medical (EHR/EMR) Records class system to include the ability to collect, store, transmit medical imaging in their native format (Dicom) and be interoperable with all existing systems.

### BRIEF DESCRIPTION OF THE DRAWINGS

FIG. 1 is a schematic representation of an exemplary communications network for implementing various embodiments of the present invention.

FIG. 2 is a block diagram of an exemplary communications network for implementing various embodiments of the present invention;

FIG. 3 is a schematic representation of the cloud service for implementing the present invention.

FIG. 4 is a block diagram illustrating an interface structure of the cloud service for implementing the present invention.

FIG. 5 is one example of a webpage from a personal health records website application enabling a user/patient to upload and manage the patient's data files.

FIG. 6 is one example of a webpage from a personal health records website application allowing a user to view, print, and transmit data files selected.

### DESCRIPTION OF THE PREFERRED EMBODIMENT

In the preferred embodiment of the present invention, an apparatus and method is provided that manages the medical records data of a patient across the continuum of care involving multiple care providers or medical institutions for the purposes of receiving medical services involving, but not limited to, the process of physician referrals, whereby a patient is referred from one physician (primary care provider) to another physician (the referred-to or receiving physician or specialist) for a particular medical procedure, or analysis or care. Unlike the prior art, the present invention is a multi-application records based platform that uses a Personal Health Records (PHR) as its foundation. The system is bunt on a patient-centered architecture that travels with the patient and is owned by the patient rather than the health care institution or medical care provider. As will be described, the present software platform as disclosed consists of components configured and correlated with respect to each other so as to attain the desired objective.

### Transfer of Patient Records

Over the course of a multi-doctor treatment process, a patient's medical records must often be transferred between several offices. Each of these transfers carries with it the possibility of document loss, and the frequent use of physical (paper) patient records only serves to increase this risk.

There is no widely used specialized procedure in place to efficiently facilitate transfer of records between healthcare providers either in private practices or Hospital-based physicians, meaning that a responsible patient and cooperative, well-organized practices must be present to ensure each doctor is properly informed. Three-way communication between the patient and multiple medical services locations is at best cumbersome, and at worst ineffective in ensuring that records are transferred completely and in a timely fashion. Breakdowns in communication and record transfers can lead to unnecessary procedures, inappropriate medication, preventable deaths, and superfluous testing that combine to create additional cost for patients and insurance providers, all the while eroding trust in medical providers and causing frustration on all sides.

The present invention is directed to a solution that provides for the capture, storage, retrieval and transmission of patients medical records including longitudinal history and imaging throughout the healthcare system environment. The present system resolves problems associated with interoperability between existing and legacy health records systems by providing one central all-inclusive repository of patient data by way of a cloud-based personal health records software solution.

According to the preferred embodiment of the invention described below, a method and apparatus are provided which allows a patient to make his/her medical information available to other medical providers, such as but not limited to, referred-to physicians and different practice groups. Document loss becomes a non-issue, as digitally archived documents cannot be lost or misplaced.

The present system defines a Personal Health Records Web Portal that serves as the central repository for all patient medical records. The personal health records module is owned and managed by the user/patient, not the healthcare system. As a result, this empowers the user/patient with the ability to collect “all” not some of the patient's medical records from “every” care provider/institution the patient visits. The present system further provides the patient/user means for managing, retrieving, collecting, parsing, records, transmitting and sharing all patient medical data and records with other medical providers.

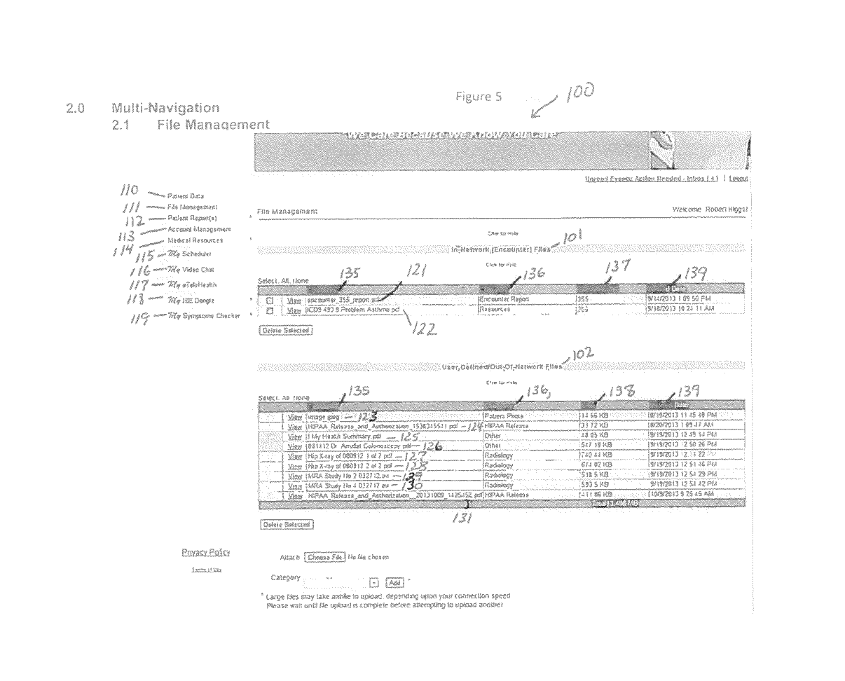

FIG. 5 is an example of a webpage 100 from a personal health records website application enabling a user/patient to upload and manage the patient's data files including imaging, report findings, laboratory, encounter summaries and medical release information.

The webpage entitled “Multi-Navigation” includes ten (10) filtering (input) windows 110-119 prompting the user to enter or select from the menu, for the following items: Patient Data 110, File Management 111, Patient Report(s) 112, Account Management 113, Medical Resources 114, My Scheduler 115, My Video Chat 116, My eTeleHealth 117, My HIE DONGLE 118, and My Symptoms Checker 119. The user clicks the selected option to access the appropriate option page. For example, FIG. 5 is an example of a webpage for the File Management 111 option. Within the File Management 111 page you are able to select from the patient's data what files to be made available to the, for example, referred-to physician. The File Management webpage lists ail the patient's in-network and out-of-network files stored in the personal health records module. The user enters the appropriate information by selecting the files to be uploaded for transmittal, thereby initiating the transfer of medical records process. Not all items (data files and records) are required to be selected, rather the user can pick among the in-network files (designated numerals 121 and 122 in FIG. 5) and/or the available out-of-network files (designated as numerals 123-131 in FIG. 5). As one example, the user could enter the Encounter Report 121, the Patient Photo 123, and the HIPAA Release 131 to be uploaded and transmitted. As illustrated, the File Management 111 page separates the data stored in In-Network (Encounter) Files 101 and User Defined/Out-of-Network Files 102, each row displaying a particular file. Each row includes a first column containing a File name 135, a second column defined as Category 136, a third column in the In-Network Files 101 containing an Encounter ID 137, a third column in the Out-of-Network Files 102 displaying the Size 138 of the stored data, and a fourth column containing the Upload Date 139.

Report viewing, printing and transmittal is available via the “Patient Report(s)” function using the same interface as for the File Management 111. The Patient Reports page 140 is associated with all data and files entered into the system and provides for the ability for the user to view and/or print any or all of the data by selection. Additionally, the Patient Reports includes a sub-menu for use by user in sending (transmitting) any or all data and files to any person via email with all data including files being encrypted.

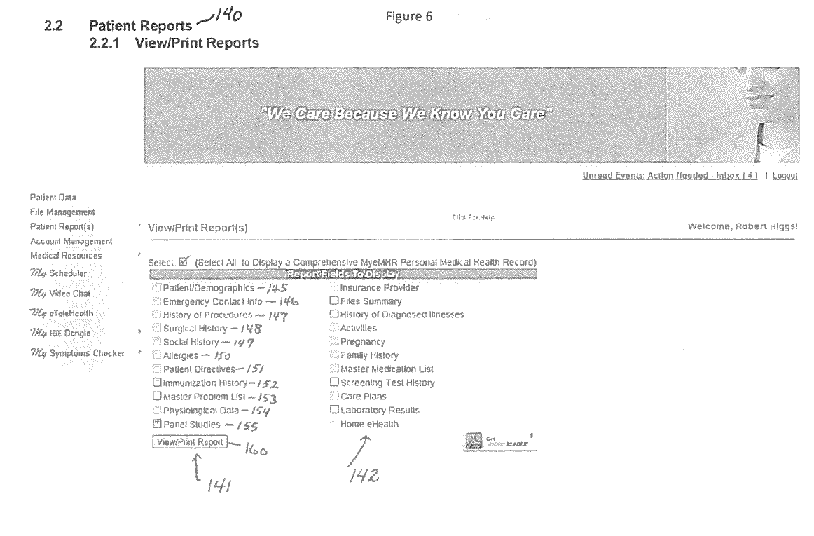

The embodiment illustrated in FIG. 6 will now be described. FIG. 6 shows a webpage 140 that enables the user to view, print, and transmit data files selected. The page, entitled “Patient Report” includes a number of fields, enabling the user to filter based on selected criteria and generate a report therefrom. Here, the filtering of windows include two (2) columns 141 and 142. Column 141 including the following fields/items: Patient/Demographics 145, Emergency Contact Info. 146, History of Procedures 147, Surgical History 148, Social History 149, Allergies 150, Patient Directives 151, Immunization History 152, Master Problem List 153, Psychological Data 154, and Panel Studies 155, Column 142, as illustrated, includes a number of fields/items as well. It should be understood that while the exemplary Patient Reports page 140 displays twenty-two (22) fields, the number of data fields may be expandable, or may be less.

The user customizes the report by selecting the data fields to be included in the report, and then initiates the report generator based on the selected filtering information. Not all items (fields) are required, rather the user can pick among the displayed fields based upon the desired information requested. As one example, the user may select the Patient/Demographics 145 field, and the History of Procedures 147 field in generating the preferred report. Once all the desired fields are selected, the user simply clicks the View/Print Report 160 below column 141, and the selected information is processed by the personal health records software module and the module returns a report consisting of the selected data fields and the relevant medical record data.

Account Management 113 is used to set up/change user profile, password and other account information. Medical Resources 114 includes links to a host of third-party websites involving medical resource information such as the National Library of Medicine and others. The My Scheduler 115 is an interactive calendar that is linked to incoming information from medical care providers regarding appointments for medical services. The My Video Chat 116 launches an interactive video/audio chat application embedded in the personal health records software module for use by users in communicating with other family members and medical care providers. My eTeleHealth 117 launches a patient data and medical information screen to include files and is used to communicate with other care providers in the United States. This function provides the ability to send any or all data in a medically accepted format such as CCR, CCD and C-CDA (structured format) whereby any receiving party can import said data directly into their medical records system. This is accomplished by creating a one-time instance dynamic web portal in such a way as to never send the information, but rather “ring” the receiving party to the data. The My HIE DONGLE 118 is a dedicated application that provides the ability to transfer and receiving a user medical information including medical files (imaging) to and from the personal health records software module and a given medical care provider using a DONGLE. The My Symptoms Checker 119 is an application that enables a user to enter a narrative common language symptoms into a screen and the application will return a list of the top ten possible diagnosis ranked in order of probability, with the ability to click on any one of them and be directed to a resource for treatment options.

The present invention uses relationship database architecture along with custom developed algorithms from which to associate data and determine a corresponding action or event with notification to the user and/or the users care provider using remote messaging and email communications.

The transfer of medical records can be initiated by either the patient or their designated representative. In cases involving the patient, the Personal Health Records Web Portal would be utilized. In application the user (patient or designated representative) selects a physician from various internal sources, selects from the personal health records module what additional medical data in addition to all structured data required by the remote or distant care provider, input a message or instructions as to the purposes of the consultation, and then transmits an encrypted message and email to the remote physician.

Upon receipt of a request to provide consultative services, the remote physician responds (clicks) on a web link as provided in the message/email, verifying receipt of same. The remote physician may then be directed by the system to a secure personal web portal before accessing the patient's medical records. All medical data is made available in structured form using the NIST standard for CCR, CCD, CDA or C-CDA for use by the remote physicians in downloading said data. Any electronic response from the remote physician, such as comments, suggestions and recommend orders (medications, tests, ect.) transmitted back to the present system is received and saved in the structured form. The system further includes a reconciliation process where the data received from the remote physician is logically compared with the data in the personal health records module to avoid duplication. In this regard, the reconciliation process is both automatic and manual in that all data received is brought to a user webpage screen and presented to the user with both existing data and newly received data so that the user can either accept or reject the inclusion (into the person& health records module) of the newly received data at the user's discretion.

It is critical to note that the use of the personal health records based system is independent of the medical care provider's own electronic medical records system but yet, capable of communicating with that system or any other medical records based system. This is the founding principle of the present system that cannot be altered.

The present disclosure relates to a system and method for processing medical information, and more particularly, to a system that provides optimal medical information service to the patient and the care provider by managing and integrative medical information processing system independently operated using a cloud system.

Domestic medical information processing technology includes Picture Archiving Communication System (PACS), Order Communication System (OCS), and Electronic Medical Record (EMR), which comply with Health Level 7 (HL7). Medical information processing is independently managed by individual hospitals. Particularly, EMR has been developed into the Electronic Health Record (EHR) concept that is a lifetime electronic health record of individual patients.

However, EHR independently operated need to be integrated according to standardization for high quality medical service of individuals. For this, integrated system technology is needed, and for example, a cloud computing model is being applied.

Cloud computing is a next generation computing technology in which Software as a Service (SaaS) for web 2.0 service and utility computing are complexly combined.

The service structure of cloud computing may include a server for using IT environment, storage, Infrastructure as a Service (IaaS), Platform as a Service for providing a basis for development of software, Software as a Service (SaaS) in which a computing provider supplies and uses software through Internet. The present system may further include mobile browser technology which is a software-manufacturing technology with an app structure used to independently provide developed services to a user in a smart environment.

### Network Communications

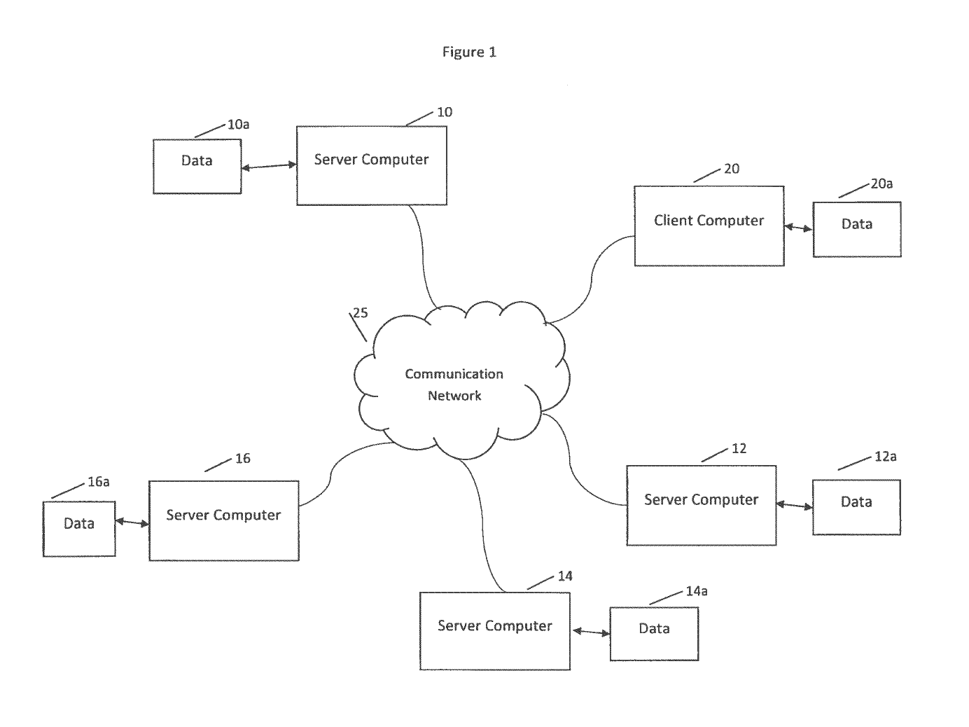

Apparatus and methods are described herein for improving the management of patient medical records including the referral process between a patient's primary care provider and the referred-to specialized physician, for example. The present system serves as the primary health services delivery component. For these purposes, network based communications are required between patients, and the subscribing physicians and physician practice groups. The block diagrams of one such communication system is illustrated in FIG. 1 and is meant to be representative only. Suitable hardware, communication protocols and software languages for implementing the systems and methods of various embodiments of the invention are readily known to those who are skilled in the art and any discussion herein is not to limit the scope of the invention.

FIG. 1 illustrates schematically network communication among various server computers 10, 12, 14, 16 and client computers 20 shown coupled together via a network or cloud 25 (e.g., the Internet) to communicate with one another using standard communication protocols. The servers can be any type of server, including but not limited to a Windows, Unix, Linux and/or Apple servers. Each server and client computer may have an attached data storage system 10a, 12a, 14a, 16a, and 20a, respectively, for storing software applications and data.

In accordance with the preferred embodiment of the present invention, the network of FIG. 1 allows communications between multiple patients, and multiple health care practitioners and health care practitioner groups, and multiple hospitals. The server(s) provides a network based service to the patients, practitioners, practitioner groups, and hospitals, and provides a web-based data processing service and interface to each of the subscribers, and can also communicate electronically via email with each of these computers and servers. The server also communicates (e.g. web-based) with each of the practice groups, hospitals via their respective servers both retrieving medical data for the respective patient's personal health records web portal, as discussed.

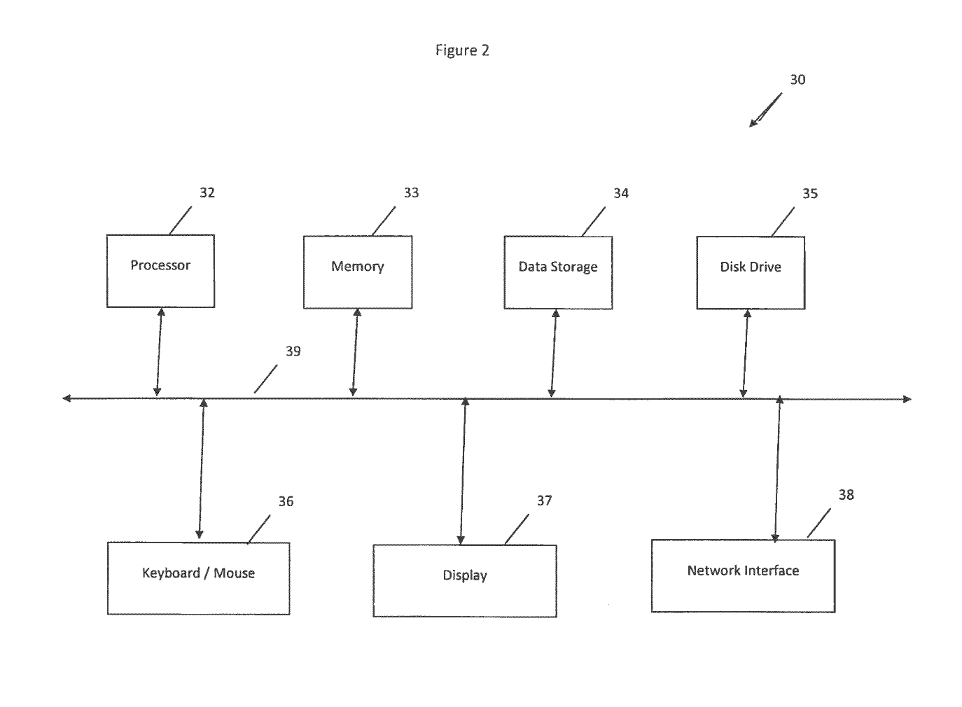

FIG. 2 is a block diagram of one server 30 which includes a processor 32, memory 33, data storage 34, disk drive 35, keyboard/mouse 36, computer display 37 and network interface 38. The components are coupled together and communicate via a system bus 39. Various software modules of the present invention can be loaded into data storage and during operation are transferred in to memory (e.g. RAM) for execution by the processor. A user (e.g. patient) may manipulate the software and enter commands to server using the keyboard/mouse. The input/output may be viewed on the display screen. The network interface couples the server to Internet or whatever type of network is used to connect the server with the other computers and servers of the respective patients, physicians, practice groups, and hospitals. Further, the server may communicate with a storage array or storage network (e.g. SAN) if there is a need to access large amounts of data. The database of patient records may be implemented as a relational database with a selected search engine from any number of search engine providers.

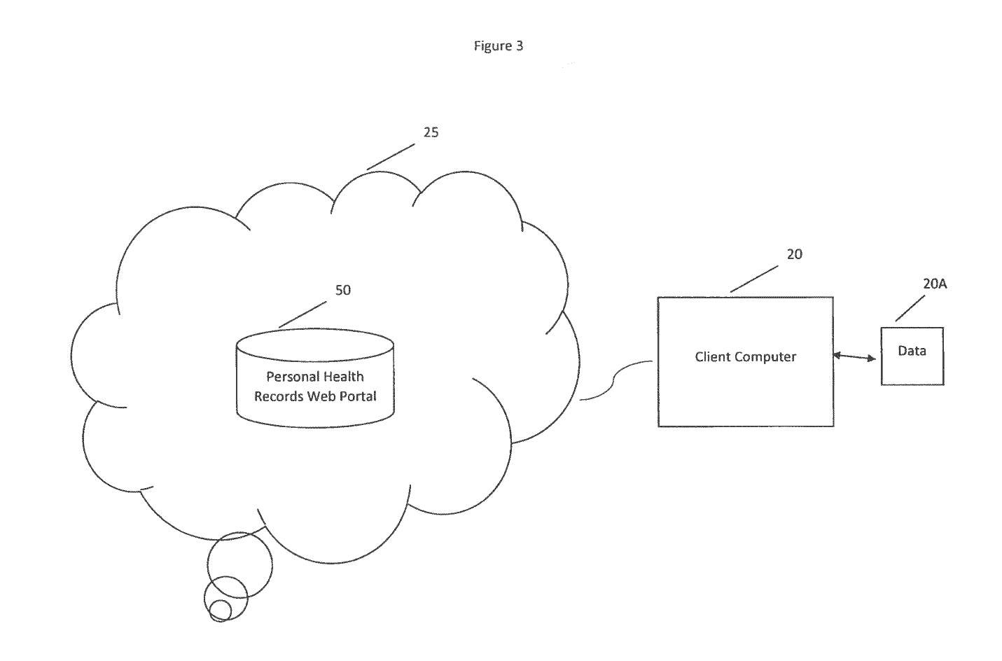

As shown in FIG. 3, in the present invention, the cloud technology 25 includes the Personal Health Records Web Portal data 50 in communications with the user terminal 20.

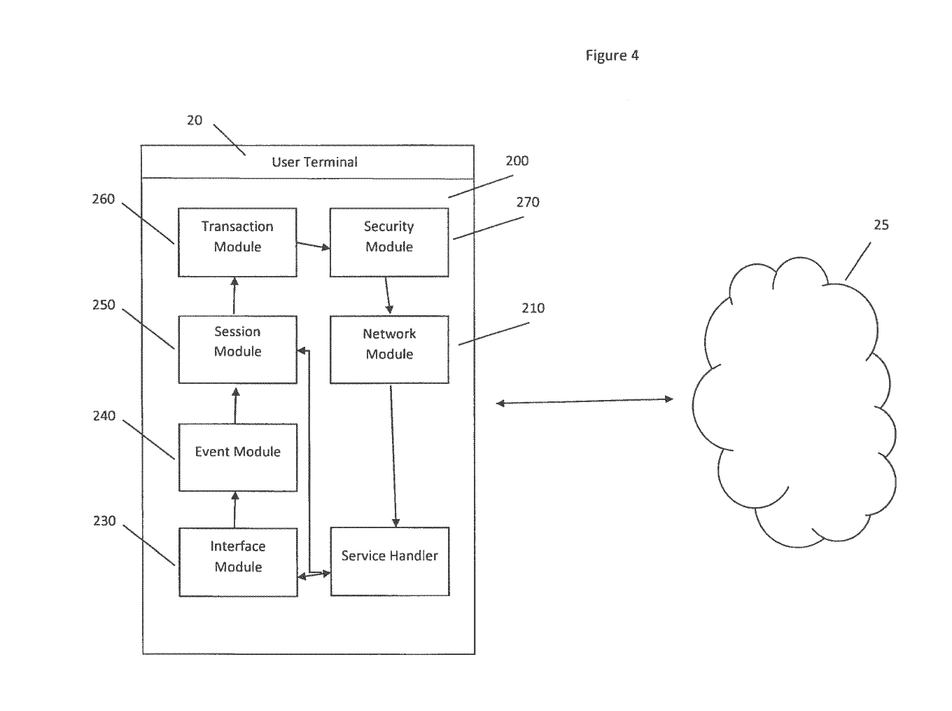

As shown in FIG. 4, in a medical information processing system, a medical information processing cloud system 25 in which information processing services are integrated may be assessed using information processing tools such as smart phone terminals and personal computers. In the present invention, a patient is endowed with access authority and use medical information services in real-time according to his/her demand.

The medical information processing system includes a service browser 200 that is included in a terminal 20 of a user in a form of application to allow the user to use a medical information processing service and induce access to the cloud service 25 taking charge of medical information processing.

Specifically, the service browser unit 200 may include a user interface module 230 providing a service application of an icon type to the user through access identification, and event module 240 generating event information, a session module 250 managing a network environment of the user and maintaining a connection situation according to a change of the network environment, a conversion module 260 encoding and converting the information into a compression code according to a predetermined protocol, a security module 270 encoding the user information configured by the conversion module to securely configure virtualization of the cloud server together with user access information, a network module 210 delivering the user information to the cloud system 25 and monitoring a network state, and a service handler 220 configuring a user interface with the information received from the cloud system 25.

The service browser unit 200 in communication with the user terminal 20. Accordingly, a user (physician/care provider) may transmit to the cloud system 25 in real-time, and may submit the user situation information generated in the interface module 230 and the event information generated in the event module to the Person& Health Records Web Portal 50 in the cloud system unit 25. The cloud system 25 providing services to a user may include a typical structure that provides a cloud service.

As used herein, database is meant to include any of various types of data repositories and processes for indexing, searching, storage and retrieval from such repositories.

An e-mail module allows encrypted e-mails with authentication to be sent to/from patients, physicians, practice groups, hospitals, via the respective server/computer. The e-mails can be sent manually by a person operating the server and can be automatically generated by the server. For example, the e-mail module can be configured to automatically query the database module and send e-mail messages to entities identified in the database module.

The software may include standard APIs so data and other information can be exchanged with other software systems. The personal health records portal can further include a DICOM viewer module for viewing and processing “native” DICOM imaging from any known source.

### Physicians and Practice Groups

In various embodiments of the present invention disclosed herein, the term “physicians”, “care providers” or “doctor” refers to a physician administering patient care, as well as to those members of his/her staff responsible for maintaining the physician's patient records. Though the term is used interchangeably, it should be understood that in the exemplary figures and texts, each function is being performed by one or more persons that perform such activities in a particular doctor's office on behalf of a licensed physician.

The term “specialist” is applied to a physician administering secondary care to a patient after a referral from a referring physician, and is also applied to other members of his/her staff in the same manner as is done for the physician. It may be possible for any given physician to in one situation be a specialist (receiving a patient via referral), and in another be a primary care physician (referring a patient to another physician for specialized care).

Further a “provider group” or “practice group” may be any entity linking a group of doctors through shared facilities, services, or referral agreements. This can include but should not be limited to integrated multi-facility hospitals, medical groups, and multi-doctor practices.

### System, Method and Computer Program

As will be appreciated by one skilled in the art, the present invention may be embodied as an apparatus or method, including a computer system or computer program product. Accordingly, unless specified to the contrary, the present invention may take the form of an entirely hardware embodiment, and entirely software embodiment (including firmware, resident software, micro-code, ect.) or an embodiment combining software and hardware aspects that may all generally be referred to herein as a “circuit,” “module” or “system.” Furthermore, the present invention may take the form of a computer program product embodied in any tangible medium of expression having computer-usable program code stored in the medium.

Any combination of one or more computer-usable or computer-readable medium(s) may be utilized, unless specified to the contrary herein. The computer-usable or computer-readable medium may be, for example, but not limited to, electronic, magnetic, optical, electromagnetic, infrared, or semiconductor storage mediums. More specific examples (a non-exhaustive list) include: a portable computer diskette, a hard disc, a random access memory (RAM), a read-only memory (ROM), an erasable programmable read-only memory (EPROM or Flash Memory), and a portable compact disc read-only memory (CDROM), an optical storage device.

Further, the present invention is described above with reference to flowchart illustrations and/or block diagrams of methods, apparatus and computer program products (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprise one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in a block diagrams and/or flowchart illustration, can be implemented by special purpose hardware-based systems that perform the specified functions or acts, or combinations of special purpose hardware and computer instructions.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

I claim:

1. An online system for managing and transmitting patient medical records, comprising:
a cloud system,
a personal health records module configured as a software application accessible to a user terminal to allow a user to use a medical information processing service, and inducing access to the cloud system taking charge of medical information processing,
wherein said personal health records module for receiving and managing patient records and transmitting access to selected patient records to third party care providers,
said personal health records module further including a user interface enabling the user to select from the user's medical records the files to be made available to the third party care provider, and transmitting access to said selected patient records,
a security module such that a referred-to physician is unable to access said transmitted selected patient records without a unique identifier.

2. The online system as recited in claim 1, wherein the user is connected to the personal health records module to transmit to the cloud system in real time.

3. The online system as recited in claim 2, wherein the personal health records module comprises an interface function of accessing from said user terminal to said cloud system and a function of outputting, managing, and software processing an event generated by the personal health records module and expressed as an icon usable by the user.

4. The online system as recited in claim 3, further including a platform connection module that provides a function of connecting between platforms for managing the cloud system for medical information processing and information resourced and allows a user terminal comprising a function of virtualizing resources necessary for service processing to access the cloud system.

5. The system as recited in claim 4, wherein the personal health records module provides a function of checking the referred-to physician's identifier, securing an authority to use and access said selected patient records.

6. The system as recited in claim 5, wherein when said user terminal is connected to the cloud system, said patient records for that user can be transmitted from said personal health records module and locally stored on said user terminal.

7. The online system as recited in claim 6, wherein said personal health records module further including an embedded video chat module that enables the user to conduct interactive HD video conferencing with the third party care provider.

8. The online system as recited in claim 7, wherein the system functions to generate and transmit said selected patient records in a format as can be transmitted to a disparate operating system and parsed into the disparate system as structured data.

9. The online system as recited in claim 8, wherein the system further includes means for receiving medical information from the third party care provider and parse said medical information into the user's patient health records module as structured data.

10. The online system as recited in claim 5, wherein the system transmits the selected patient records to the third party care provider such that the third party care provider is granted access to the selected patient records via a portal in the cloud system.

11. The online system as recited in claim 9, further including a reconciliation means to compare a response by the referred-to physician with the patient records on the personal health records module.

12. The online system as recited in claim 11, wherein said response is in said structured data format.
